(19) United States
(12) Patent Application Publication
(10) Pub. No.: US 2025/0035875 A1
(43) Pub. Date: Jan. 30, 2025

(54) FIBER CABLE ENCLOSURE CONFIGURED TO COUPLE WITH AN OPTICAL NETWORK TERMINAL AND PREVENT REMOVAL THEREFROM

(71) Applicant: PPC BROADBAND, INC., East Syracuse, NY (US)

(72) Inventors: Jerin RAJ, Coimbatore (TN) (IN); Abilash NEVILLE, Ernakulam (KL) (IN)

(73) Assignee: PPC BROADBAND, INC., East Syracuse, NY (US)

(21) Appl. No.: 18/787,975

(22) Filed: Jul. 29, 2024

(30) Foreign Application Priority Data
Jul. 28, 2023 (IN) 202321051044

(51) Int. Cl. G02B 6/44

(52) U.S. Cl. CPC G02B 6/4471

(57) ABSTRACT

A cable enclosure may include a body portion including an exterior surface portion having an attachment portion that may be structurally configured to couple with a mounting portion of a telecommunications component. A first portion of the attachment portion may be structurally configured to slidingly receive the mounting portion of the telecommunications component and bias the mounting portion, and a second portion of the attachment portion may be structurally configured to remove the bias from the mounting portion of the telecommunications component such that the mounting portion of the telecommunications component is permitted to prevent sliding movement of the telecommunications component relative to the body portion so as to retain the telecommunications component on the exterior surface portion of the body portion.

### CROSS REFERENCE TO RELATED APPLICATION

This application claims the benefit of Indian Provisional Patent Application No. 202321051044, filed in India on Jul. 28, 2023, the disclosure of which is hereby incorporated by reference herein in its entirety.

### TECHNICAL FIELD

The present disclosure is directed to a fiber cable enclosure, for example, a home termination box, to a fiber termination box having an attachment portion configured to couple with an optical network terminal.

### BACKGROUND

Signal transmission via cables have advanced over time to allow relatively sophisticated interconnects. The proliferation of fiber optic cables has allowed greater signal transfer speeds with less latency and errors. However, the use of multiple different types and sizes of cables, along with the interconnection of cables with a variety of different components, connectors, and adapters, can be relatively complex and pose time consuming difficulties during installation. For instance, termination of one or more cables at a residence, business, or distribution site can be complex and time consuming to organize and install. For these reasons, there is a continued goal of terminating signal transmission cables with an assembly that makes interconnection and installation of cables at a site more efficient.

It may be desirable to provide a fiber cable enclosure, for example, a home termination box, to a fiber termination box having an attachment portion configured to couple with an optical network terminal and prevent removal therefrom.

### SUMMARY

In accordance with various aspects of the disclosure, a fiber enclosure having an exterior portion configured to retain an optical network terminal may include a body portion including a fiber cable port portion. The body portion may include a bottom wall portion, a top wall portion, and a side wall portion between the bottom wall portion and the side wall portion, and the top wall portion, the bottom wall portion, and the side wall portion may be structurally configured to define an enclosure having an interior portion. The top wall portion may be structurally configured to be detached from the side wall portion to permit access to the interior portion of the enclosure. The top wall portion may include an exterior surface portion having an attachment portion that is structurally configured to couple with a mounting portion of an optical network terminal. The attachment portion may include a first receiving portion structurally configured to slidingly receive the mounting portion of the optical network terminal in a first direction and a second receiving portion structurally configured to be accessible from the first receiving portion in a second direction perpendicular to the first direction. The first receiving portion may be structurally configured to bias the mounting portion in a biasing direction that is opposite to the second direction such that the first receiving portion slidingly receives the mounting portion of the optical network terminal in the first direction, and the second receiving portion may be structurally configured to remove the bias on the mounting portion of the optical network terminal by the first receiving portion such that the mounting portion of the optical network terminal is permitted to extend into the second receiving portion, thereby preventing sliding movement of the optical network terminal relative to the top wall portion in the first direction, so as to retain the exterior surface portion of the top wall portion coupled with the optical network terminal.

Some embodiments of the fiber enclosure may further include an interconnect configured to optically couple an input fiber with an output fiber. In some aspects, the interconnect may include a splice connection, a splitter, or an adapter.

According to any of the foregoing embodiments of the fiber enclosure, the first receiving portion may include a recessed portion in the exterior surface portion of the top wall portion, and the second receiving portion may include an opening portion in a side wall portion of the recessed portion.

In some aspects, a coupling arrangement structurally configured to couple an optical network terminal with a fiber enclosure may include the fiber enclosure of any of the foregoing embodiments and an optical network terminal structurally configured to be coupled with the fiber enclosure. The optical network terminal may include a mounting portion that includes a biasing portion structurally configured to be biased in the second direction from an unbiased configured to a biased configuration so as to permit the optical network terminal to be slidingly received in the first receiving portion of the fiber enclosure in the first direction. The biasing portion may be structurally configured to be received in the second receiving portion of the fiber enclosure in the second direction, thereby permitting the biasing portion to return toward the unbiased configuration, so as to prevent sliding movement of the optical network terminal relative to the top wall portion in the first direction and retain the optical network terminal on the exterior surface portion of the top wall portion.

According to any of the foregoing embodiments of the coupling arrangement, the first receiving portion of the fiber enclosure may include a recessed portion in the exterior surface portion of the top wall portion, and the second receiving portion may include an opening portion in a side wall portion of the recessed portion. The second receiving portion may be structurally configured to permit the mounting portion to move toward the interior portion of the fiber enclosure to latch to the top wall portion so as to prevent sliding movement of the optical network terminal relative to the top wall portion in the first direction and retain the optical network terminal on the exterior surface portion of the top wall portion.

According to any of the foregoing embodiments of the coupling arrangement, the fiber port portion may be disposed in the side wall portion of the fiber enclosure, and the fiber port portion may include a first port and a second port that are disposed perpendicular to one another. The fiber enclosure may include a first connector receiving portion, a second connector receiving portion, and a third connector receiving portion each extending from an interior surface portion of the bottom wall portion. The first connector receiving portion may be disposed between the first port and the second port, the second connector receiving portion is disposed on an opposite side of the first port relative to the first connector receiving portion, and the third connector receiving portion may be disposed on an opposite side of the second port relative to the first connector receiving portion. The fiber enclosure may include a connector portion having a first fastener receiving portion configured to be coupled with the first connector receiving portion and a second fastener receiving portion configured to be coupled with the second connector receiving portion to clamp a fiber passing through first port. In some aspects of the coupling arrangement, the second fastener receiving portion may be configured to be detached from the second connector receiving portion such that the connector portion is configured to be pivoted about the first connector receiving portion to couple the second fastener receiving portion with the third connector receiving portion to clamp a fiber passing through second port.

In accordance with various aspects of the disclosure, a cable enclosure having an exterior portion configured to retain a telecommunications component may include a body portion having a top wall portion that includes an exterior surface portion having an attachment portion that is structurally configured to couple with a mounting portion of a telecommunications component. The attachment portion may include a first receiving portion structurally configured to slidingly receive the mounting portion of the telecommunications component and a second receiving portion structurally configured to be accessible from the first receiving portion. The first receiving portion may be structurally configured to bias the mounting portion such that the first receiving portion slidingly receives the mounting portion of the telecommunications component, and the second receiving portion may be structurally configured to remove the bias on the mounting portion of the telecommunications component by the first receiving portion such that the mounting portion of the telecommunications component is permitted to extend into the second receiving portion, thereby preventing sliding movement of the telecommunications component relative to the top wall portion, so as to retain the exterior surface portion of the top wall portion coupled with the telecommunications component.

Some embodiments of the cable enclosure may further include an interconnect configured to optically couple an input fiber with an output fiber. In some aspects, the interconnect may include a splice connection, a splitter, or an adapter.

According to any of the foregoing embodiments of the cable enclosure, the first receiving portion may include a recessed portion in the exterior surface portion of the top wall portion, and the second receiving portion may include an opening portion in a side wall portion of the recessed portion.

According to any of the foregoing embodiments of the cable enclosure, the body portion may further include a bottom wall portion and a side wall portion between the bottom wall portion and the side wall portion, and the top wall portion, the bottom wall portion, and the side wall portion may be structurally configured to define an enclosure having an interior portion. In some aspects, the top wall portion may be structurally configured to be detached from the side wall portion to permit access to the interior portion of the enclosure.

In some aspects, a coupling arrangement structurally configured to couple a telecommunications component with a cable enclosure may include the cable enclosure of any of the foregoing embodiments and a telecommunications component structurally configured to be coupled with the cable enclosure. The telecommunications component may include a mounting portion that includes a biasing portion structurally configured to be biased in the second direction from an unbiased configured to a biased configuration so as to permit the telecommunications component to be slidingly received in the first receiving portion of the top wall portion in the first direction. The biasing portion may be structurally configured to be received in the second receiving portion of the cable enclosure in the second direction, thereby permitting the biasing portion to return toward the unbiased configuration, so as to prevent sliding movement of the telecommunications component relative to the top wall portion in the first direction and retain the telecommunications component on the exterior surface portion of the top wall portion.

According to any of the foregoing embodiments of the coupling arrangement, the cable enclosure may include a fiber optic cable enclosure, and the telecommunications component may include an optical network terminal.

According to any of the foregoing embodiments of the coupling arrangement, the first receiving portion of the cable enclosure may include a recessed portion in the exterior surface portion of the top wall portion, and the second receiving portion may include an opening portion in a side wall portion of the recessed portion. The second receiving portion may be structurally configured to permit the mounting portion to move toward the interior portion of the cable enclosure to latch to the top wall portion so as to prevent sliding movement of the telecommunications component relative to the top wall portion in the first direction and retain the telecommunications component on the exterior surface portion of the top wall portion.

According to any of the foregoing embodiments of the coupling arrangement, the side wall portion of the cable enclosure may include a cable port portion, and the cable port portion may include a first port and a second port that are disposed perpendicular to one another. The cable enclosure may include a first connector receiving portion, a second connector receiving portion, and a third connector receiving portion each extending from an interior surface portion of the bottom wall portion. The first connector receiving portion may be disposed between the first port and the second port, the second connector receiving portion may be disposed on an opposite side of the first port relative to the first connector receiving portion, and the third connector receiving portion may be disposed on an opposite side of the second port relative to the first connector receiving portion. The cable enclosure may include a connector portion having a first fastener receiving portion configured to be coupled with the first connector receiving portion and a second fastener receiving portion configured to be coupled with the second connector receiving portion to clamp a cable passing through first port. The second fastener receiving portion may be configured to be detached from the second connector receiving portion such that the connector portion is configured to be pivoted about the first connector receiving portion to couple the second fastener receiving portion with the third connector receiving portion to clamp a cable passing through second port.

In accordance with various aspects of the disclosure, a cable enclosure having an exterior portion configured to retain a telecommunications component may include a body portion including an exterior surface portion having an attachment portion that is structurally configured to couple with a mounting portion of a telecommunications component. A first portion of the attachment portion may be structurally configured to slidingly receive the mounting portion of the telecommunications component and bias the mounting portion, and a second portion of the attachment portion may be structurally configured to remove the bias from the mounting portion of the telecommunications component such that the mounting portion of the telecommunications component is permitted to prevent sliding movement of the telecommunications component relative to the body portion so as to retain the exterior surface portion of the body portion coupled with the telecommunications component.

Some embodiments of the cable enclosure may further include an interconnect configured to optically couple an input fiber with an output fiber. In some aspects, the interconnect may include a splice connection, a splitter, or an adapter.

According to any of the foregoing embodiments of the cable enclosure, the first portion of the attachment portion may include a recessed portion in the exterior surface portion, and the second portion of the attachment portion may include an opening portion in a side wall portion of the recessed portion.

According to any of the foregoing embodiments of the cable enclosure, the body portion may include a bottom wall portion, a top wall portion, and a side wall portion between the bottom wall portion and the side wall portion, the top wall portion may include the exterior surface portion, and wherein the top wall portion, the bottom wall portion, and the side wall portion may be structurally configured to define an enclosure having an interior portion. According to some aspects, the top wall portion may be structurally configured to be detached from the side wall portion to permit access to the interior portion of the enclosure.

In some aspects, a coupling arrangement structurally configured to couple a telecommunications component with a cable enclosure may include the cable enclosure of any of the foregoing embodiments and a telecommunications component structurally configured to be coupled with the cable enclosure. The telecommunications component may include a mounting portion that includes a biasing portion structurally configured to be biased in the second direction from an unbiased configured to a biased configuration so as to permit the telecommunications component to be slidingly received in the first portion of the attachment portion in a first direction. The biasing portion may be structurally configured to be received in the second portion of attachment portion in a second direction perpendicular to the first direction, thereby permitting the biasing portion to return toward the unbiased configuration, so as to prevent sliding movement of the telecommunications component relative to the body portion in the first direction and retain the telecommunications component on the exterior surface portion of the body portion.

According to any of the foregoing embodiments of the coupling arrangement, the cable enclosure may include a fiber optic cable enclosure, and the telecommunications component may include an optical network terminal.

According to any of the foregoing embodiments of the coupling arrangement, the first portion of the attachment portion may include a recessed portion in the exterior surface portion, and the second portion of the attachment portion may include an opening portion in a side wall portion of the recessed portion, and the second portion of the attachment portion may be structurally configured to permit the mounting portion to move toward an interior portion of the cable enclosure to latch to the body portion so as to prevent sliding movement of the telecommunications component relative to the body portion in the first direction and retain the telecommunications component on the exterior surface portion of the body portion.

According to any of the foregoing embodiments of the coupling arrangement, the cable enclosure may include a side wall portion having a cable port portion, and the cable port portion may include a first port and a second port that are disposed perpendicular to one another. The cable enclosure may include a first connector receiving portion, a second connector receiving portion, and a third connector receiving portion each extending from an interior surface portion of the body portion. The first connector receiving portion may be disposed between the first port and the second port, the second connector receiving portion may be disposed on an opposite side of the first port relative to the first connector receiving portion, and the third connector receiving portion may be disposed on an opposite side of the second port relative to the first connector receiving portion. The cable enclosure may include a connector portion having a first fastener receiving portion configured to be coupled with the first connector receiving portion and a second fastener receiving portion configured to be coupled with the second connector receiving portion to clamp a cable passing through first port. In some aspects, the second fastener receiving portion may be configured to be detached from the second connector receiving portion such that the connector portion is configured to be pivoted about the first connector receiving portion to couple the second fastener receiving portion with the third connector receiving portion to clamp a cable passing through second port.

In accordance with various aspects of the disclosure, a cable enclosure may include body portion having a bottom wall portion, a top wall portion, and a side wall portion between the bottom wall portion and the side wall portion. The top wall portion, the bottom wall portion, and the side wall portion are structurally configured to define an enclosure having an interior portion. The side wall portion of the cable enclosure may include a cable port portion, and the cable port portion may include a first port and a second port that are disposed perpendicular to one another. The cable enclosure may include a first connector receiving portion, a second connector receiving portion, and a third connector receiving portion each extending from an interior surface portion of the bottom wall portion. The first connector receiving portion may be disposed between the first port and the second port, the second connector receiving portion is disposed on an opposite side of the first port relative to the first connector receiving portion, and the third connector receiving portion is disposed on an opposite side of the second port relative to the first connector receiving portion. The cable enclosure may include a connector portion having a first fastener receiving portion configured to be coupled with the first connector receiving portion and a second fastener receiving portion configured to be coupled with the second connector receiving portion to clamp a cable passing through first port.

In some aspects, the second fastener receiving portion may be configured to be detached from the second connector receiving portion such that the connector portion is configured to be pivoted about the first connector receiving portion to couple the second fastener receiving portion with the third connector receiving portion to clamp a cable passing through second port.

### BRIEF DESCRIPTION OF THE DRAWINGS

Further advantages and features of the present disclosure will become apparent from the following description and the accompanying drawings to which reference is made.

FIG. 1 is a block representation of an exemplary coupling arrangement for an optical network terminal and a fiber cable enclosure in accordance with various aspects of the disclosure.

FIG. 2 is a perspective view of an exemplary a fiber cable enclosure of the coupling arrangement of FIG. 1 in accordance with various aspects of the disclosure.

FIG. 3 is a plan view of an exemplary optical network terminal of the coupling arrangement of FIG. 1 in accordance with various aspects of the disclosure.

FIG. 4 is a perspective view of the exemplary coupling arrangement of FIG. 1.

FIG. 5 is a cross-sectional perspective view of portions of the exemplary coupling arrangement of FIG. 4.

FIG. 6A shows a top view of portions of the exemplary coupling arrangement of FIG. 1.

FIG. 6B shows a top view of portions of the exemplary coupling arrangement of FIG. 1.

FIG. 7A illustrates a top view of portions of a first configuration of an exemplary fiber cable enclosure in accordance with various aspects of the disclosure.

FIG. 7B illustrates a top view of portions of a second configuration of the exemplary fiber cable enclosure of FIG. 7A.

FIG. 8 is an exploded perspective view of the exemplary fiber cable enclosure of FIG. 7A.

### DETAILED DESCRIPTION

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

With greater numbers of cable termination sites to service increasing numbers of customers, cable termination boxes are more frequently employed. The ability to alter cable configurations and interconnected components can result in greater access and interactions with assorted aspects of a terminal box. As such, a terminal box can be improved by allowing more efficient access, alteration, and installation of cable components.

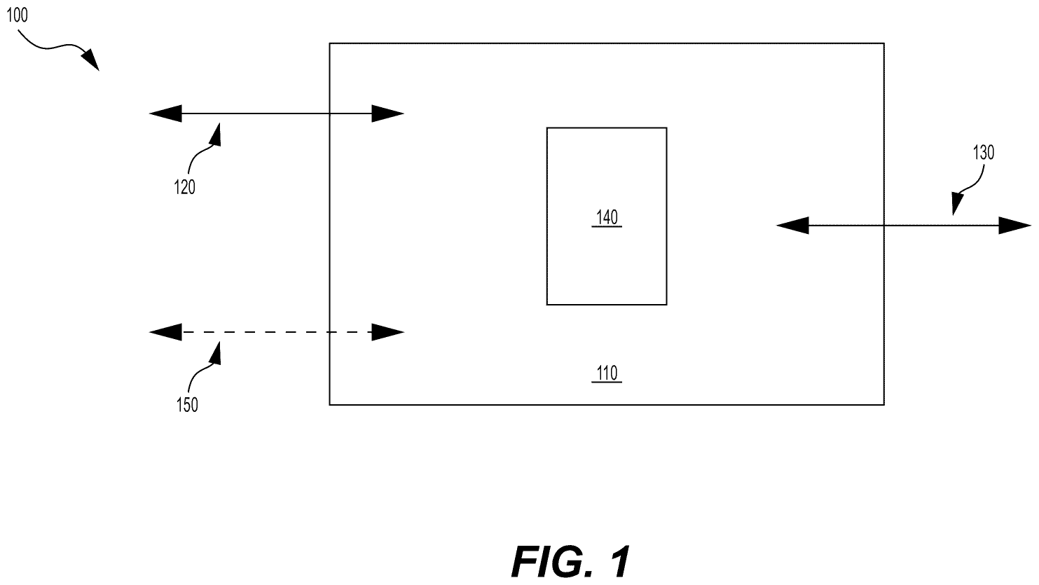

Referring to FIG. 1, a cable enclosure or fiber enclosure 110, for example, a fiber optic cable termination box or a home termination box, may be configured to receive an input cable 120, such as a fiber optic cable, that connects to an output cable 130 via one or more interconnects 140. It is noted that the terminal box 110 can be concurrently accessed by multiple cables, as shown with segmented cable 150, that provide signal transmission pathways that simultaneously carry signals and/or data to and/or from the enclosure 110.

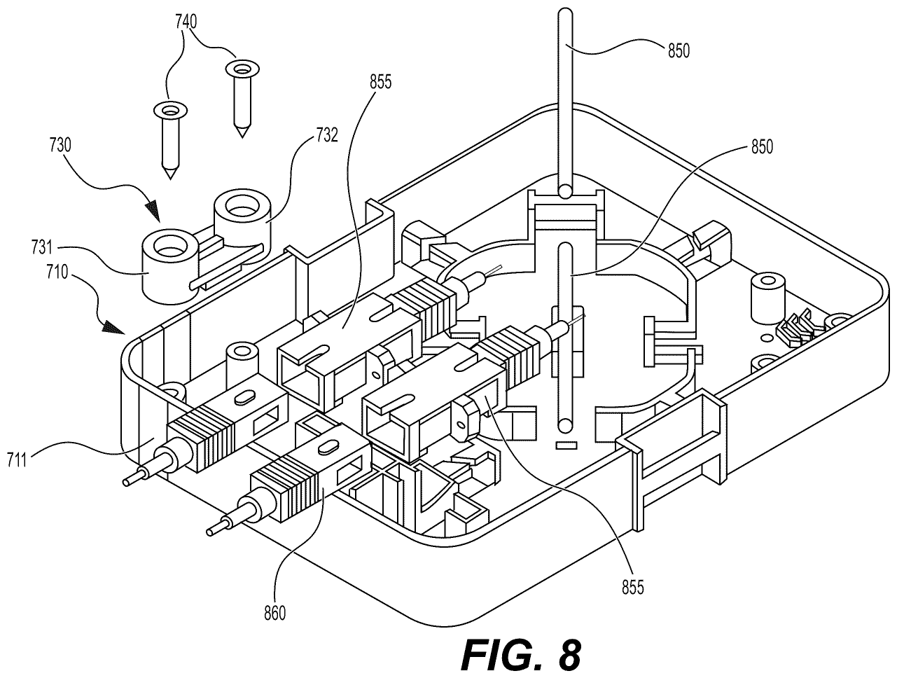

The terminal box 110 can house any number, type, and size of interconnects 140 that terminates one cable 120 and begin a second cable 130. For instance, referring to FIG. 8, the interconnect 140 may comprise a splice protector 850, an adapter 855, a cartridge, a coupler, a splitter, or any connector that changes size, type, and/or signal transmission capabilities. More specifically, an interconnect can reduce the size of an input cable 120 to an output cable 130 size that is conducive to residential site utilization. However, the installation of a terminal box 110 at a residential site with multiple interconnections and subsequent access for cable management can pose interconnection integrity challenges along with relatively long access times.

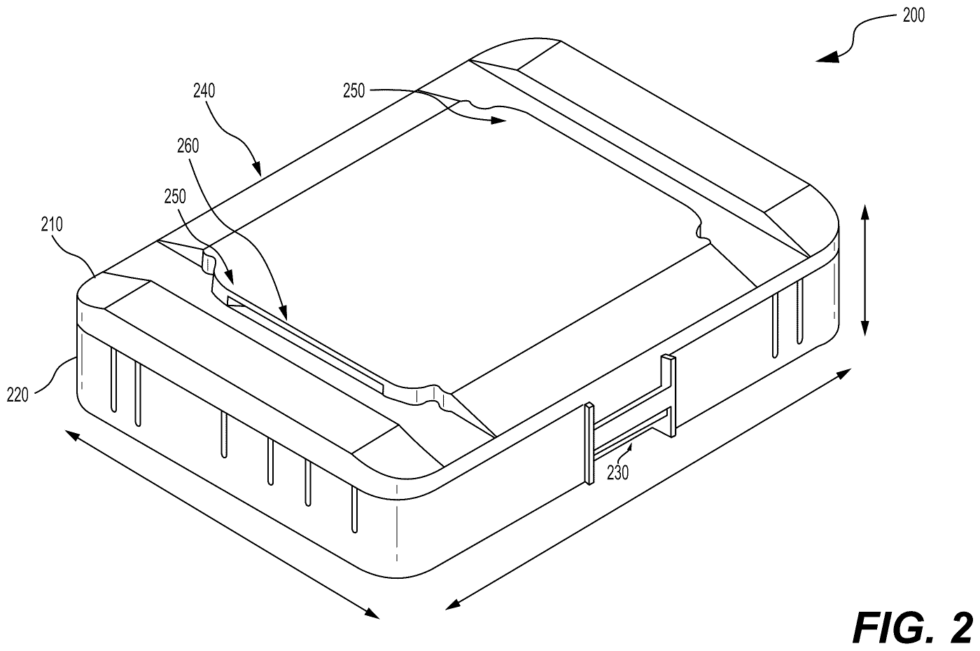

Accordingly, various embodiments are directed to a terminal box system that can provide robust installation and cable management capabilities with reduced access and installation times. FIG. 2 displays a perspective view of an exemplary cable enclosure or fiber enclosure 200, for example, a home termination box, that can be utilized as part of a system to provide optimized structure and operation. As shown, the terminal box 200 may comprises a body portion 220 having a bottom wall portion 222, a side wall portion 224, and a top wall portion 210. In some aspects, the top wall portion 210 may comprise a lid or cover portion that is configured to align with a body or body portion 220 and has a closure portion 230, which may include one or more closures, that allows selected access to the interior area defined by the body 220 and lid 210. For example, the top wall portion 210 may be configured to be removed from the side wall portion 224 or be moved relative to the side wall portion to permit access to the interior.

The number, type, size, and position of various closures 230 on the terminal box 200 are not limited to a particular configuration, but in some embodiments, the terminal box may have a hinge closure 230 that operates to allow the lid 210 to move and articulate relative to the body 220 and a latch closure 230 that allows the lid 210 to be secured to the body 220. The body 220 has a number of separate ports that can be selected for cable access into, and out of, the interior of the terminal box 200. That is, selected regions of the body 220 can be removed to allow a cable, such as a fiber optic or coaxial cable, access to an interconnect 140 positioned within the box 200 without opening the lid 210 or releasing a latch closure 230.

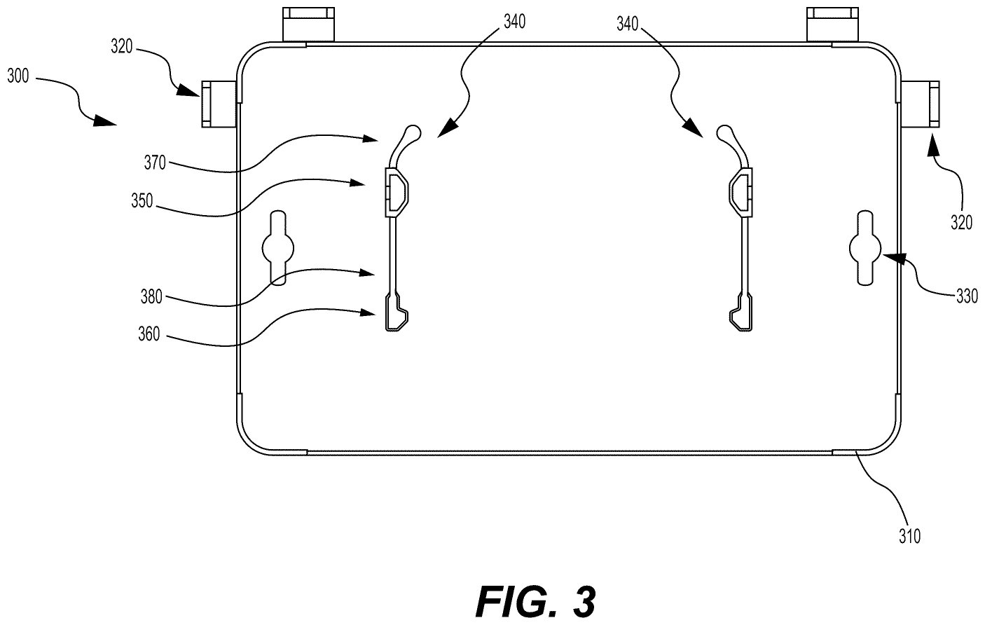

The lid 210 is configured, in accordance with various embodiments, to have an attachment portion 240 that allows the box 200 to receive and retain, or securely hold, a telecommunications component, for example, an optical network terminal (ONT) 300, as illustrated in FIG. 3. In some aspects, the telecommunications component may comprise a different component of a telecommunications system than an ONT. It is contemplated that the attachment portion 240 further allows for removal and reattachment to a mounting portion 340 of the ONT 300.

An exterior surface portion of the top wall portion 210 may include the attachment portion. The attachment portion 240 may comprise a first receiving portion 250 and a second receiving portion 260. Although not required or limiting, in some aspects, the first receiving portion 250 may comprise a channel, and in some aspects may include more than one channels, in the exterior outer surface of the top wall portion 210.

Each channel 250 has a shape, depth, and the second receiving portion 260, for example, an opening or aperture, that provides access to portions of a mounting portion of a telecommunications component, as shown in FIG. 3. Specifically, each channel 250 is configured with a sidewall shape, depth, and second receiving portion 260 sized to allow secure engagement, and selective access, of the second receiving portion 260 with portions of a mounting plate 300 to enable the terminal box 200 to be attached, removed, and reattached to the mounting portion 340 of the ONT 300.

Turning to FIG. 3, a top view of portions of the mounting portion 340 of the ONT 300 are displayed that can be employed with the terminal box 200 of FIG. 2 as part of a coupling arrangement. A surface or surface portion 310 of the mounting portion 340 is arranged above cable ports 320 of the ONT 200 that provide cable organization and routing options conducive to a diverse variety of installation sites and conditions. The surface 310 may provide one or more mounting openings 330 that can be accessed with a fastener (not shown) to secure the ONT 300 to an underlying surface, such as a wall, post, eave, or pole.

The top surface 310 presents the box mounting portion 340, for example, a pair of mounting portions, that are configured to engage the attachment portion 240 of the terminal box 200 to physically attach and secure the ONT 300 to the fiber enclosure 200. It is noted that the number, size, position, and constituent aspects of the mounting portion 340 shown in FIG. 3 are not limiting. For example, as shown in the embodiment of FIG. 3, each mounting portion 340 may include a biasing portion 350, for example, a tab portion, having a flexible or articulating lock portion 360 on a first side of the tab portion 350 and a slide stop portion 370 on an opposite second side of the tab portion 350.

Each tab portion 350 and lock portion 360 can move relative to the top surface 310 to engage and secure the ONT 300 to portions of the attachment portion 240 of the terminal box 200. For example, the tab 350 and lock portion 360 can independently move relative to the top surface 310 to allow the mounting portion 340 to slide along the first receiving portion 250 until a wall of the second receiving portion 250 contacts the slide stop portion 370 of the mounting portion 340.

The articulable configuration of the tab portion 350 and lock portion 360 allows for automatic engagement of portions of the first receiving portion 250 and the second receiving portion, respectively, with the mounting portion 340 to secure the ONT 300 with the cover portion 210, for example, in physical contact with each other in some aspects. In other words, the tab portion 350 and lock portion 360 can provide spring forces that respond to contact with the first receiving portion 250 and the second receiving portion 260 to attach the terminal box 200 in contact with the mounting portion of the ONT 300. The size, shape, and position of the slide guide portion 380 and slide stop portion 370 are configured to match the configuration of the first receiving portion 250 so that installation of the attachment portion 240 to the ONT 300 is efficient and accurate.

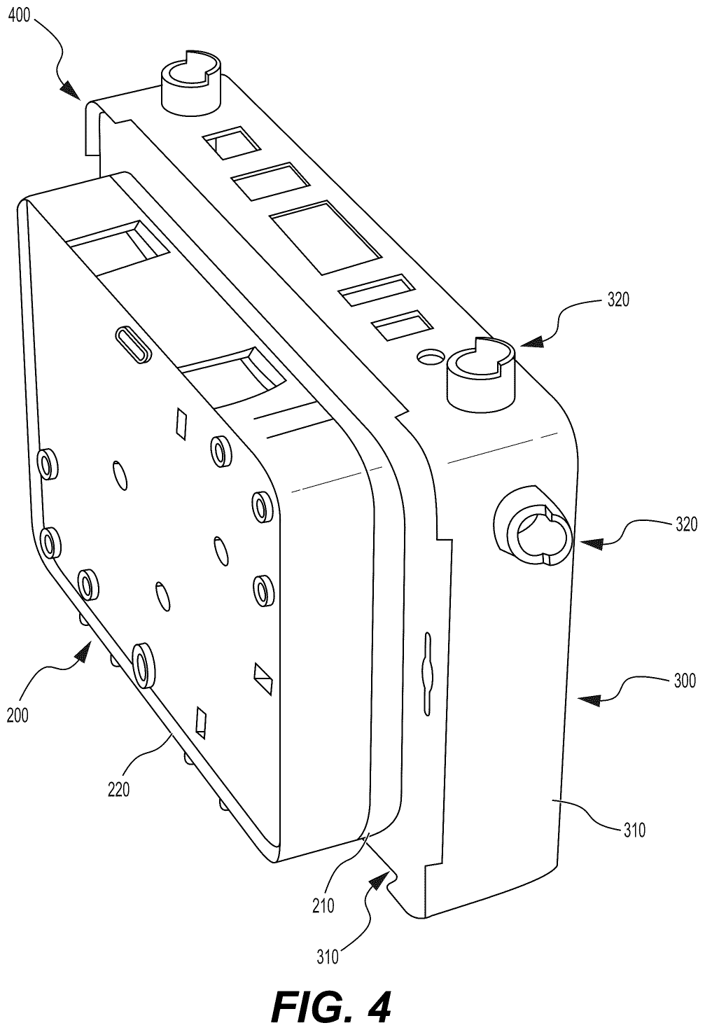

FIG. 4 displays a perspective view of an example cable enclosure or fiber enclosure 400 arranged in accordance with various embodiments to secure the cable enclosure 200 to the ONT 300 (or some other type of telecommunications component). As a result of a sliding movement of the cable enclosure 200 along the top surface 310 of the ONT 300, the first receiving portion 250 of the attachment portion 240 push the tab portion 350 and lock portion 360 of the mounting portion 340 to allow a wall portion of the first receiving portion 250 to engage the slide stop portion 370.

It is contemplated that the respective aspects of the mounting portion 340 and attachment portion allow the fiber enclosure 200 to move, vibrate, and/or oscillate without jeopardizing the secure physical connection to the mounting plate 300. Hence the mounting portion 340 provided by the telecommunications component 300 may comprise a suspension that absorbs and/or dampens energy while maintaining a secure physical mount of the cable enclosure 200 with the ONT 300, which can be particularly useful in installation environments prone to motion, wind, and/or vibration.

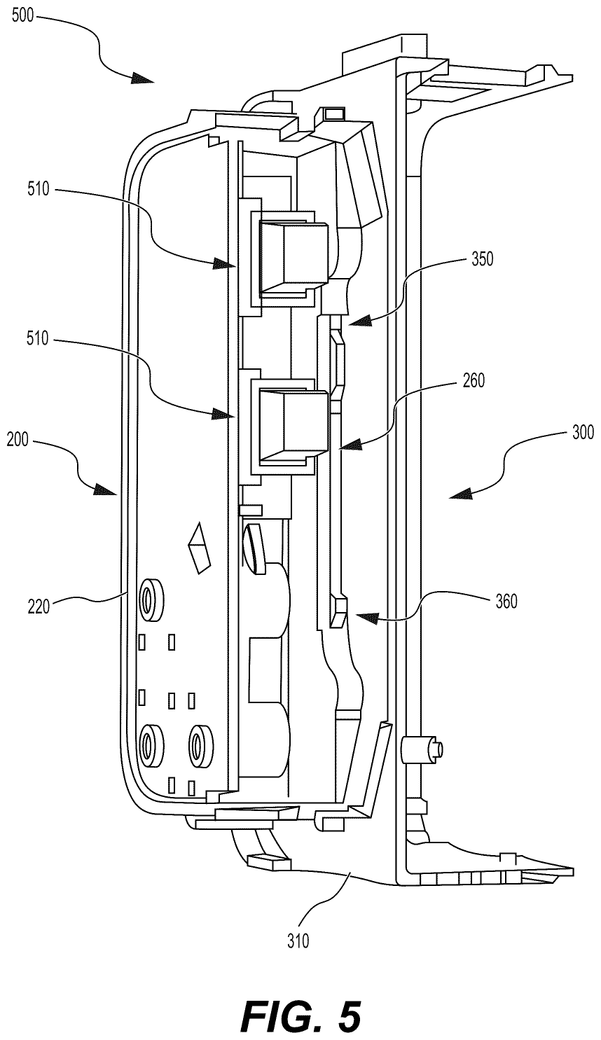

FIG. 5 illustrates a cross-sectional line representation of portions of an example terminal box system 500 configured to provide selective retention of the terminal box 200 on the mounting plate 300 in accordance with various embodiments. It is noted that the arrangement of FIG. 5 matches that shown in FIG. 4 with the terminal box 200 contacting, and secured to, the telecommunications component 300, for example, an ONT as shown, via engagement of the attachment portion 240 with the mounting portion 340.

The cross-section of FIG. 5 conveys how the mounting tab portion 350 extends into the second receiving portion 260, for example, an opening or aperture, to secure the terminal box 200 with the ONT while providing a degree of movement and/or vibration in the box 200 to occur without jeopardizing the secure physical connection with the mounting plate 300. That is, the mounting tab portion 350 can maintain the position of the terminal box 200 while allowing some movement and/or vibration due to the floating arrangement of the tab portion 350 and consistent spring force applied onto the terminal box 200 once the first receiving portion 250 fully engages the entirety of the mounting portion 340, which can be defined as the first receiving portion 250 concurrently contacting the slide stop portion 370 and the lock portion 360, as shown.

While not required, the lock portion 360 can articulate with constant spring force to fill portions of the same second receiving portion 260 as the tab portion 350. Other embodiments may have the lock portion 360 engage a separate attachment portion opening 260 than the mounting suspension tab 350. For example, the second receiving portion 260 may comprise two or more separate openings (not shown). The combination of the tab portion 350 and lock portion 360 concurrently engaging portions of the attachment portion 240, along with the first receiving portion 250 contacting the slide stop 370 of the mounting portion 340, ensures the terminal box 200 is physically secured with the ONT 300 while being able to absorb/dampen encountered motion and vibration.

The cross-sectional view of FIG. 5 further conveys how the terminal box 200 can house multiple interconnects 140 that allow a cable to alter from input to output. For instance, the terminal box 200 can have multiple couplers 510, for example, adapters, that can respectively couple a first portion of cable with a new portion of the cable, which allows for changes in size, type, and position of a cable exiting the terminal box 200.

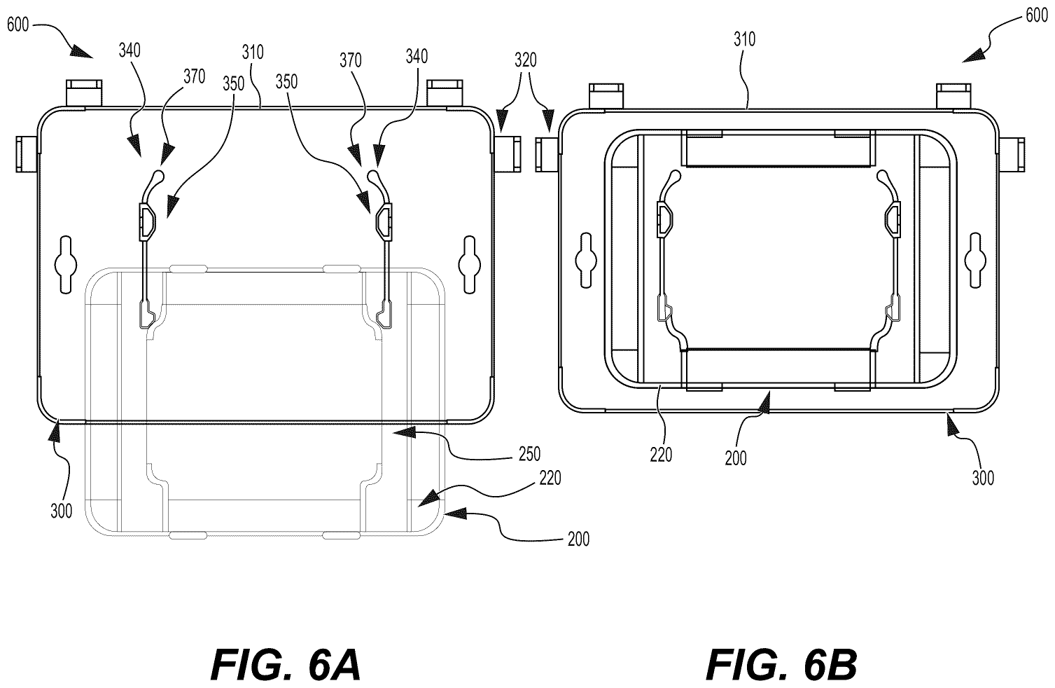

FIGS. 6A and 6B respectively display top view line representations of portions of an example terminal box system 600 configured and operated in accordance with various embodiments. The system 600 shown in FIG. 6A conveys how the terminal box 200 is orientated to the mounting plate 300 during installation and removal. That is, the terminal box 200 is arranged so that the first receiving portion 250 of the attachment portion 240 are facing the surface 310 of the ONT 300, as conveyed by the shadowed features of the top wall portion 210 while the body portion 220 is actually facing away from the surface 310.

The arrangement of the terminal box 200 with respect to the mounting surface 310 shows how the first receiving portion 250 of the attachment portion 240 aligns with the mounting portion 340 to allow the first receiving portion 250 to slidingly receive the mounting portion 340 of the ONT 300, which causes portions of the first receiving portion 250 to contact and sequentially displace the lock portion 360 and the tab portion 350 until a wall portion of the first receiving portion 250 reaches the slide stop 370 and the displaced aspects of the mounting portion 340 spring into the second receiving portion 260 to secure the terminal box 200 in place relative to the ONT 300, as shown in FIG. 6B.

In other words, forcing the terminal box 200 to engage the mounting portion 340 with the first receiving portion 250 of the lid's attachment portion 240 automatically extends the articulating aspects of the mounting portion 340 and the spring force of those aspects subsequently causes the aspects to automatically engage and occupy the second receiving portion 260 to retain the terminal box 200 on the ONT 300 and, in some aspects, in contact with the surface 310 of the ONT 300, as shown in FIG. 6B.

The ability to automatically engage and secure the terminal box 200 to the ONT 300 simply by sliding the box 200 along the top surface 310 increases accuracy and efficiency of box installation. In contrast, manual articulation of individual attachment mechanisms, such as latches, snaps, buttons, or keys, can be difficult to manipulate to accurately locate and secure the terminal box 200 onto the top surface 310 of the ONT 300.

It is noted that the articulating aspects of the mounting portion 340 can be manually manipulated to allow removal of the terminal box 200 from the telecommunications component 300 without damaging the box 200 or the mounting portion 340. As a result, one or more terminal boxes 200 can be cyclically attached, removed, and reattached to the ONT 300 at will, which increases the practicality of the terminal box system 600 by being adaptable over time.

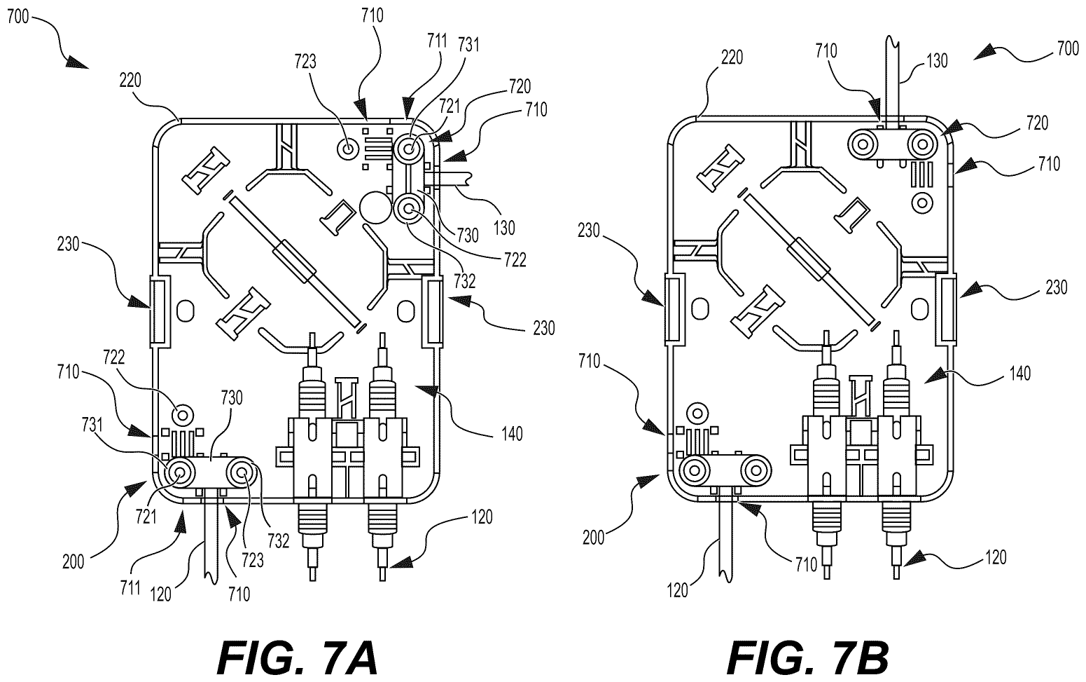

FIGS. 7A and 7B respectively illustrate portions of an example terminal box 700 that can be employed in the terminal box systems of FIGS. 4-6B in accordance with various embodiments or independently of such terminal box systems. Each top view representation of the inside of a terminal box 700 shows how cabling 120, 130 such as fiber optic cables of differing size and/or signal transmission capability, can terminate at an interconnect 140 or a splice that produces one or more output cable 120, 130.

The terminal box body portion 220 has a continuous sidewall where multiple ports 710, 711 are present. A port 710, 711 can be selectively opened, such as by removing or moving a port cap, to allow cables of a diverse variety of sizes to extend into, and out of, the interior cavity defined by the box body sidewalls. The availability of multiple different ports 710, 711 allows for a variety of different cabling configurations, as generally shown in FIGS. 7A and 7B. More specifically, FIG. 7A shows how a cable can enter and exit at different angles (e.g., right angles) relative to the box body 220 while FIG. 7B shows how cabling can be configured in a parallel orientation relative to the box body 220.

The diverse cabling configurations provided by the terminal box body 220 are complemented by different cable securing options. The non-limiting embodiments shown in FIGS. 7A and 7B illustrate how a connector portion 720 is configured to secure a cable to the interior of the box body 220. The terminal box body 220 has a number of mount installation sites where a cable mount 720 can be attached, such as with a fastener, snap, latch, or keyed engagement. The ability to secure cables in a variety of different port 710 configurations allows the terminal box 700 to be employed safely in many different arrangements and environments.

For example, a side wall portion 220 of the cable enclosure 700 may include a cable port portion 720, and the cable port portion may include a first port 710 and a second port 711 that are disposed perpendicular to one another. The cable enclosure may include a first connector receiving portion 721, a second connector receiving portion 722, and a third connector receiving portion 723 each extending from an interior surface portion of the bottom wall portion. As illustrated, the first connector receiving portion 721 is disposed between the first port 710 and the second port 711, the second connector receiving portion 722 is disposed on an opposite side of the first port 710 relative to the first connector receiving portion 721, and the third connector receiving portion 723 is disposed on an opposite side of the second port 711 relative to the first connector receiving portion 721. The cable enclosure may include a connector portion 730 having a first fastener receiving portion 731 configured to be coupled with the first connector receiving portion 721 and a second fastener receiving portion 732 configured to be coupled with the second connector receiving portion 722 to clamp a cable passing through first port 710. The second fastener receiving portion 732 may be configured to be detached from the second connector receiving portion 722 such that the connector portion is configured to be pivoted about the first connector receiving portion 721 to couple the second fastener receiving portion 732 with the third connector receiving portion 723 to clamp a cable passing through second port 711.

FIG. 8 illustrates portions of an example terminal box system 800 arranged in accordance with assorted embodiments. As shown by the exploded view of the home terminal box (HTB), fasteners 740 can be used to secure the connector 730 and multiple cable adapter interconnects can be provided within the terminal box body. The exploded view of FIG. 8 further shows how a splicing sleeve 850 can be positioned within the terminal box body. It is noted that features provided in the interior of the terminal box body can be configured to secure cable, such as loops, hooks, or channel.

Through the use of a terminal box system, cable management can be safely and reliably secured in a variety of different sites. The availability of multiple different ports and securing mounts allows a terminal box to be arranged in a variety of different manners and configurations that support reliable cable delivery. The secure mating of a terminal box lid to a mounting plate provides efficient installation and subsequent cable management.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber enclosure having an exterior portion configured to be coupled with an optical network terminal and prevent removal therefrom comprising:
a body portion including a fiber cable port portion;
wherein the body portion includes a bottom wall portion, a top wall portion, and a side wall portion between the bottom wall portion and the side wall portion, and wherein the top wall portion, the bottom wall portion, and the side wall portion are structurally configured to define an enclosure having an interior portion;
wherein the top wall portion is structurally configured to be detached from the side wall portion to permit access to the interior portion of the enclosure;
wherein the top wall portion includes an exterior surface portion having an attachment portion that is structurally configured to couple with a mounting portion of an optical network terminal;
wherein the attachment portion includes a first receiving portion structurally configured to slidingly receive the mounting portion of the optical network terminal in a first direction;
wherein the attachment portion opening includes a second receiving portion structurally configured to be accessible from the first receiving portion in a second direction perpendicular to the first direction;
opening wherein the first receiving portion is structurally configured to bias the mounting portion in a biasing direction that is opposite to the second direction such that the first receiving portion slidingly receives the mounting portion of the optical network terminal in the first direction; and
wherein the second receiving portion is structurally configured to remove the bias on the mounting portion of the optical network terminal by the first receiving portion such that the mounting portion of the optical network terminal is permitted to extend into the second receiving portion, thereby preventing sliding movement of the optical network terminal relative to the top wall portion in the first direction, so as to retain the exterior surface portion of the top wall portion coupled with the optical network terminal.

2. The fiber enclosure of claim 1, further comprising an interconnect configured to optically couple an input fiber with an output fiber.

3. The fiber enclosure of claim 2, wherein the interconnect comprises a splice connection, a splitter, or an adapter.

4. The fiber enclosure of claim 1, wherein the first receiving portion comprises a recessed portion in the exterior surface portion of the top wall portion, and the second receiving portion comprises an opening portion in a side wall portion of the recessed portion.

5. A coupling arrangement structurally configured to couple an optical network terminal with a fiber enclosure comprising:
the fiber enclosure of claim 1;
an optical network terminal structurally configured to be coupled with the fiber enclosure;
wherein the optical network terminal comprises a mounting portion that includes a biasing portion structurally configured to be biased in the second direction from an unbiased configured to a biased configuration so as to permit the optical network terminal to be slidingly received in the first receiving portion of the fiber enclosure in the first direction; and
wherein the biasing portion is structurally configured to be received in the second receiving portion of the fiber enclosure in the second direction, thereby permitting the biasing portion to return toward the unbiased configuration, so as to prevent sliding movement of the optical network terminal relative to the top wall portion in the first direction.

6. The coupling arrangement of claim 5, wherein the first receiving portion of the fiber enclosure comprises a recessed portion in the exterior surface portion of the top wall portion, and the second receiving portion comprises an opening portion in a side wall portion of the recessed portion; and
wherein the second receiving portion is structurally configured to permit the mounting portion to move toward the interior portion of the fiber enclosure to latch to the top wall portion so as to prevent sliding movement of the optical network terminal relative to the top wall portion in the first direction.

7. The coupling arrangement of claim 5, wherein the fiber port portion is disposed in the side wall portion of the fiber enclosure, and the fiber port portion includes a first port and a second port that are disposed perpendicular to one another;
wherein the fiber enclosure comprises a first connector receiving portion, a second connector receiving portion, and a third connector receiving portion each extending from an interior surface portion of the bottom wall portion;
wherein the first connector receiving portion is disposed between the first port and the second port, the second connector receiving portion is disposed on an opposite side of the first port relative to the first connector receiving portion, and the third connector receiving portion is disposed on an opposite side of the second port relative to the first connector receiving portion; and
wherein the fiber enclosure includes a connector portion having a first fastener receiving portion configured to be coupled with the first connector receiving portion and a second fastener receiving portion configured to be coupled with the second connector receiving portion to clamp a fiber passing through first port.

8. The coupling arrangement of claim 7, wherein the second fastener receiving portion is configured to be detached from the second connector receiving portion such that the connector portion is configured to be pivoted about the first connector receiving portion to couple the second fastener receiving portion with the third connector receiving portion to clamp a fiber passing through second port.

9. A cable enclosure having an exterior portion configured to be coupled with a telecommunications component and prevent removal therefrom comprising:
a body portion comprising a top wall portion that includes an exterior surface portion having an attachment portion that is structurally configured to couple with a mounting portion of a telecommunications component;
wherein the attachment portion includes a first receiving portion structurally configured to slidingly receive the mounting portion of the telecommunications component;
wherein the attachment portion includes a second receiving portion structurally configured to be accessible from the first receiving portion;
wherein the first receiving portion is structurally configured to bias the mounting portion such that the first receiving portion slidingly receives the mounting portion of the telecommunications component; and
wherein the second receiving portion is structurally configured to remove the bias on the mounting portion of the telecommunications component by the first receiving portion such that the mounting portion of the telecommunications component is permitted to extend into the second receiving portion, thereby preventing sliding movement of the telecommunications component relative to the top wall portion, so as to retain the exterior surface portion of the top wall portion coupled with the telecommunications component.

10. The cable enclosure of claim 9, further comprising an interconnect configured to optically couple an input fiber with an output fiber.

11. The cable enclosure of claim 10, wherein the interconnect comprises a splice connection, a splitter, or an adapter.

12. The cable enclosure of claim 9, wherein the first receiving portion comprises a recessed portion in the exterior surface portion of the top wall portion, and the second receiving portion comprises an opening portion in a side wall portion of the recessed portion.

13. The cable enclosure of claim 9, wherein the body portion further comprises a bottom wall portion and a side wall portion between the bottom wall portion and the side wall portion, and wherein the top wall portion, the bottom wall portion, and the side wall portion are structurally configured to define an enclosure having an interior portion.

14. The cable enclosure of claim 13, wherein the top wall portion is structurally configured to be detached from the side wall portion to permit access to the interior portion of the enclosure.

15. A coupling arrangement structurally configured to couple a telecommunications component with a cable enclosure comprising:
the cable enclosure of claim 9;
a telecommunications component structurally configured to be coupled with the cable enclosure;
wherein the telecommunications component comprises a mounting portion that includes a biasing portion structurally configured to be biased in the second direction from an unbiased configured to a biased configuration so as to permit the telecommunications component to be slidingly received in the first receiving portion of the top wall portion in the first direction; and
wherein the biasing portion is structurally configured to be received in the second receiving portion of the cable enclosure in the second direction, thereby permitting the biasing portion to return toward the unbiased configuration, so as to prevent sliding movement of the telecommunications component relative to the top wall portion in the first direction.

16. The coupling arrangement of claim 15, wherein the cable enclosure comprises a fiber optic cable enclosure, and the telecommunications component comprises an optical network terminal.

17. The coupling arrangement of claim 15, wherein the first receiving portion of the cable enclosure comprises a recessed portion in the exterior surface portion of the top wall portion, and the second receiving portion comprises an opening portion in a side wall portion of the recessed portion; and
wherein the second receiving portion is structurally configured to permit the mounting portion to move toward the interior portion of the cable enclosure to latch to the top wall portion so as to prevent sliding movement of the telecommunications component relative to the top wall portion in the first direction.

18. The coupling arrangement of claim 15, wherein the side wall portion of the cable enclosure includes a cable port portion, and the cable port portion includes a first port and a second port that are disposed perpendicular to one another;
wherein the cable enclosure comprises a first connector receiving portion, a second connector receiving portion, and a third connector receiving portion each extending from an interior surface portion of the bottom wall portion;
wherein the first connector receiving portion is disposed between the first port and the second port, the second connector receiving portion is disposed on an opposite side of the first port relative to the first connector receiving portion, and the third connector receiving portion is disposed on an opposite side of the second port relative to the first connector receiving portion; and
wherein the cable enclosure includes a connector portion having a first fastener receiving portion configured to be coupled with the first connector receiving portion and a second fastener receiving portion configured to be coupled with the second connector receiving portion to clamp a cable passing through first port.

19. The coupling arrangement of claim 18, wherein the second fastener receiving portion is configured to be detached from the second connector receiving portion such that the connector portion is configured to be pivoted about the first connector receiving portion to couple the second fastener receiving portion with the third connector receiving portion to clamp a cable passing through second port.

20. A cable enclosure having an exterior portion configured to be coupled with a telecommunications component and prevent removal therefrom comprising:
a body portion comprising an exterior surface portion having an attachment portion that is structurally configured to couple with a mounting portion of a telecommunications component;
wherein a first portion of the attachment portion is structurally configured to slidingly receive the mounting portion of the telecommunications component and bias the mounting portion, and a second portion of the attachment portion is structurally configured to remove the bias from the mounting portion of the telecommunications component such that the mounting portion of the telecommunications component is permitted to prevent sliding movement of the telecommunications component relative to the body portion so as to retain the exterior surface portion of the body portion coupled with the telecommunications component.

21. The cable enclosure of claim 20, further comprising an interconnect configured to optically couple an input fiber with an output fiber.

22. The cable enclosure of claim 21, wherein the interconnect comprises a splice connection, a splitter, or an adapter.

23. The cable enclosure of claim 20, wherein the first portion of the attachment portion comprises a recessed portion in the exterior surface portion, and the second portion of the attachment portion comprises an opening portion in a side wall portion of the recessed portion.

24. The cable enclosure of claim 20, wherein the body portion comprises a bottom wall portion, a top wall portion, and a side wall portion between the bottom wall portion and the side wall portion, wherein the top wall portion includes the exterior surface portion, and wherein the top wall portion, the bottom wall portion, and the side wall portion are structurally configured to define an enclosure having an interior portion.

25. The cable enclosure of claim 24, wherein the top wall portion is structurally configured to be detached from the side wall portion to permit access to the interior portion of the enclosure.

26. A coupling arrangement structurally configured to couple a telecommunications component with a cable enclosure comprising:
the cable enclosure of claim 20;
a telecommunications component structurally configured to be coupled with the cable enclosure;
wherein the telecommunications component comprises a mounting portion that includes a biasing portion structurally configured to be biased in the second direction from an unbiased configured to a biased configuration so as to permit the telecommunications component to be slidingly received in the first portion of the attachment portion in a first direction; and
wherein the biasing portion is structurally configured to be received in the second portion of attachment portion in a second direction perpendicular to the first direction, thereby permitting the biasing portion to return toward the unbiased configuration, so as to prevent sliding movement of the telecommunications component relative to the body portion in the first direction.

27. The coupling arrangement of claim 26, wherein the cable enclosure comprises a fiber optic cable enclosure, and the telecommunications component comprises an optical network terminal.

28. The coupling arrangement of claim 26, wherein the first portion of the attachment portion comprises a recessed portion in the exterior surface portion, and the second portion of the attachment portion comprises an opening portion in a side wall portion of the recessed portion; and
wherein the second portion of the attachment portion is structurally configured to permit the mounting portion to move toward an interior portion of the cable enclosure to latch to the body portion so as to prevent sliding movement of the telecommunications component relative to the body portion in the first direction.

29. The coupling arrangement of claim 26, wherein the cable enclosure includes a side wall portion having a cable port portion, and the cable port portion includes a first port and a second port that are disposed perpendicular to one another;
wherein the cable enclosure comprises a first connector receiving portion, a second connector receiving portion, and a third connector receiving portion each extending from an interior surface portion of the body portion;
wherein the first connector receiving portion is disposed between the first port and the second port, the second connector receiving portion is disposed on an opposite side of the first port relative to the first connector receiving portion, and the third connector receiving portion is disposed on an opposite side of the second port relative to the first connector receiving portion; and
wherein the cable enclosure includes a connector portion having a first fastener receiving portion configured to be coupled with the first connector receiving portion and a second fastener receiving portion configured to be coupled with the second connector receiving portion to clamp a cable passing through first port.

30. The coupling arrangement of claim 29, wherein the second fastener receiving portion is configured to be detached from the second connector receiving portion such that the connector portion is configured to be pivoted about the first connector receiving portion to couple the second fastener receiving portion with the third connector receiving portion to clamp a cable passing through second port.
